(19) United States
(12) Patent Application Publication
(10) Pub. No.: US 2002/0055919 A1
(43) Pub. Date: May 9, 2002

(54) Method and system for gathering, organizing, and displaying information from data searches

(75) Inventor: Andrei Mikheev, Edinburgh (GB)

Correspondence Address: DARBY & DARBY, 805 THIRD AVENUE, 27TH FLR., NEW YORK, NY, 10022, US

(73) Assignee: Harlequin Limited

(21) Appl. No.: 09/823,284

(22) Filed: Mar. 30, 2001

Related U.S. Application Data
(60) Provisional application No. 60/193,811, filed on Mar. 31, 2000.

(51) Int. Cl. G06F 17/30; G09G 5/00

(52) U.S. Cl. 707/3; 345/738; 345/854; 707/10

(57) ABSTRACT

A search engine that organizes the search results into clusters of files having logical relationship. Clusters are determined according to select phrases found in the files hosted on servers in a computer network. The select phrases are determined by the search engine or the user or a combination of the two. The clusters assist the user in tailoring its search for files.

### FIELD OF THE INVENTION

This invention is related to a method and system for displaying data. More particularly, this invention is related to a method and system for organizing and displaying data generated from a search of a wide library of potential source files, such as data generated by an Internet search engine.

### BACKGROUND OF THE INVENTION

The Internet has provided individual users with direct access to an enormous amount of information. However, because of the sheer volume of information which is available, it is increasingly difficult for users to locate the documents in which they are most interested. Various search tools exist which allow a user to perform basic searches of indexed documents. FIG. 1 is an illustration of the environment of a conventional Internet search engine, such as Google, Alta-Vista, etc. As shown, a plurality of content servers containing various documents are connected to the Internet. A search engine connected to the Internet explores the content of documents which are located on the servers and generates a search index.

The search engine is accessible to users by means of a query interface. Using the interface, the user can initiate a simple search of the index to locate specifically indexed documents that contain one or more keywords. In a conventional search, a generally unstructured list of document hits is returned. A typical search result list contains the entries which identify a document's name or title, its location (i.e., an HTTP address), and a brief text field which contains, e.g., an abstract of the document, a list of relevant terms from the document, or a portion of document text surrounding the indexed keyword.

Although this type of search is useful when the query includes infrequently used keywords which are of limited general use, in most circumstances and unacceptably large number of hits are returned, forcing the user to sift through volumes of generally irrelevant material in order to find those specific documents in is which they are interested. For example, a user interested in documents which describe Harlequin software can initiate a search using the keyword “harlequin”. A typical search engine is likely to have many tens of thousands of documents containing this keyword and which address subjects which include not only Harlequin software, but also Harlequin romances, Harlequin novels, and Harlequin ducks, for example.

Accordingly, there exists a need to more precisely analyze and refine the search results provided from a conventional Internet search engine in order to permit the user to quickly identify those documents of interest and discard hits which, while containing the search terms, address unrelated subjects.

### SUMMARY OF THE INVENTION

In the method according to one aspect of the invention, a search engine analyzes files satisfying a query from the user and organized them in a logical fashion that allows the user to focus on the files in which the user is most interested. To organize the files, the search engine determines one or more phrases in the files that satisfy the query. The search engine groups the files into clusters according to the phrases found in the files as well as the servers hosting the files. Finally the search engine displays a graphical representation of the clusters for the user.

In one aspect of the present invention, a search engine has a phrase extraction module and a visualization tool. The phrase extraction module determines significant phrases contained in the files, wherein the phrases typically exclude the query terms. The phrase extractor also associates the files into clusters or groups according to the phrases in the files and the servers hosting the files. A cluster includes a phrase and the servers hosting files containing the phrase as well as other phrases contained in the files hosted on the servers as well as other servers hosting files containing any of the additional phrases. The visualization tool displays a graphical representation of the clusters according to the grouping of phrases and servers.

According to a further aspect of the invention, the specific concepts identified in a desired cluster can be used to form a refined search query which is then resubmitted to one or more search engines. This feature of the invention is particularly useful for search engines which return only a limited number of hits, e.g., 500. By refining the search, the number of irrelevant hits will be reduced and the likelihood that relevant documents will be identified is increased. The results from the refined search can be processed according to the invention.

According to yet a further aspect of the invention, once a relevant cluster has been defined and identified, the identified search documents on those servers are downloaded and processed to develop additional contextual links between the documents themselves.

### BRIEF DESCRIPTION OF THE DRAWINGS OF THE PREFERRED EMBODIMENT

FIG. 1 is a block diagram showing a search engine in the prior art;

FIG. 2 is a flow chart showing the method of the preferred embodiment of the present invention;

FIG. 3 is a block diagram showing the search engine of the preferred embodiment;

FIG. 4 is a screen print of a conventional user interface showing search results of a search engine;

FIG. 5 is a schematic showing mapping of the preferred embodiment;

FIG. 6 is a schematic showing further mapping of the preferred embodiment;

FIG. 7 is a screen print showing clusters or grouping of search results in the preferred embodiment;

FIG. 8 is a screen print showing the selection of clusters from a search result in the preferred embodiment;

FIG. 9 is a schematic showing details of the selected clusters of the preferred embodiment;

FIG. 10 is a screen print showing deleted clusters from search results in the preferred embodiment;

FIG. 11 is a screen print showing another selection of clusters from a search result in the preferred embodiment;

FIG. 12 is a schematic showing details of the selected clusters of the preferred embodiment;

FIG. 13 is a screen print showing deleted clusters from the search results in the preferred embodiment;

FIG. 14 is a screen print showing the selection of a cluster of the preferred embodiment;

FIG. 15 is a schematic showing further details of the selected cluster of the preferred embodiment;

FIG. 16 is a schematic showing the selection of a server in a cluster of the preferred embodiment;

FIG. 17 is a schematic showing the importation of concepts into the cluster of the preferred embodiment;

FIG. 18 is a schematic showing the selection of another server in a cluster of the preferred embodiment;

FIG. 19 is a schematic showing the importation of concepts into the cluster of the preferred embodiment;

FIG. 20 is a schematic showing the selection of a concept in the cluster of the preferred embodiment;

FIG. 21 is a schematic showing the addition of a server into the cluster of the preferred embodiment;

FIG. 22 is a schematic showing the importation of a concept into the cluster of the preferred embodiment;

FIG. 23 is a schematic showing the addition of documents in the display of the cluster of the preferred embodiment;

FIG. 24 is a schematic showing an alternate presentation of a cluster in the preferred embodiment;

FIG. 25 is a screen print showing user input of a query in the preferred embodiment; and

FIG. 26 is a schematic showing the linking of document in the preferred embodiment.

### DETAILED DESCRIPTION OF THE PREFERRED EMBODIMENTS

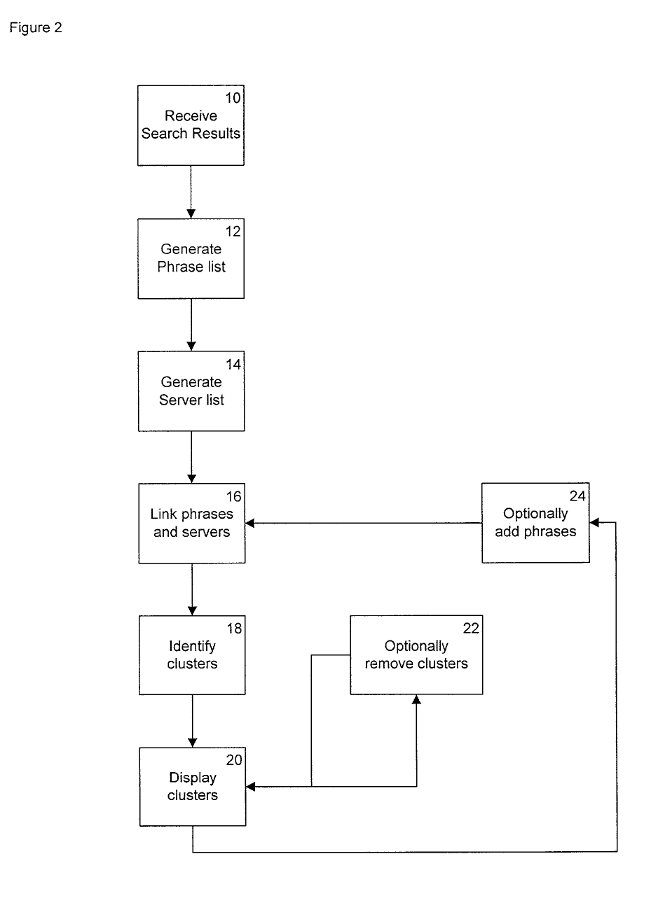

In the preferred embodiment of the present invention, the search engine performs the following steps to process search results generated by a conventional search engine and finally display the search results in manageable logical units. Referring to FIG. 2, at step 10, the initial index search results, such as the search results returned from a conventional Internet search engine, are processed at step 12 to generate a list of phrases or concepts associated with the documents identified by the search engine. The servers upon which the documents reside are also determined and at step 14, a list of the servers which contain the documents is also generated. At step 16, the entries in the lists of servers and concept phrases are then linked to indicate, for each server, the identified concepts contained by the documents identified in the search which reside on that server. The resulting data map linking servers to concepts is processed at step 18, to identify discrete clusters of servers which are linked to each other via various concept-server links. At step 20, the clusters are displayed using a visualization tool. The user can explore the concepts associated with each cluster to identify the cluster which contains the concepts most closely related to the search objective and to identify relationships between various concepts and servers.

Advantageously, servers which are present within a single cluster are linked via related concepts and, therefore, the documents from the search which are located on clustered servers are highly likely to relate to the same underlying subject matter, particularly if the number of identified concepts used to define the clusters are limited, e.g., to the most frequently used concepts (absent the search terms themselves). Thus, a user can quickly locate a cluster of servers which contain the concepts that best match the documents the user is attempting to locate. Once the cluster has been identified, irrelevant clusters can be removed from the search, at step 22, additional concepts associated with the relevant cluster can be added to the displayed information graph, at step 24, and the user can quickly retrieve a list of only those documents from initial search results which are present in the appropriate cluster. In this manner, a search which returns a very large number of hits can be quickly analyzed and the relevant documents from that search identified.

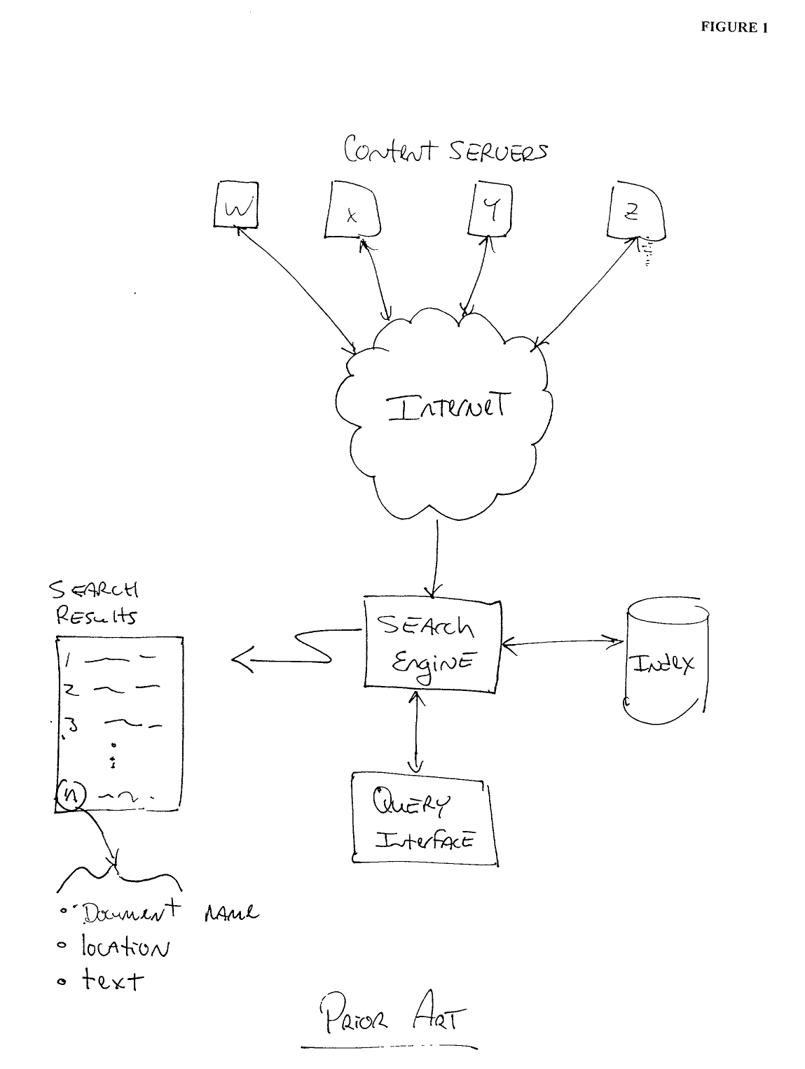

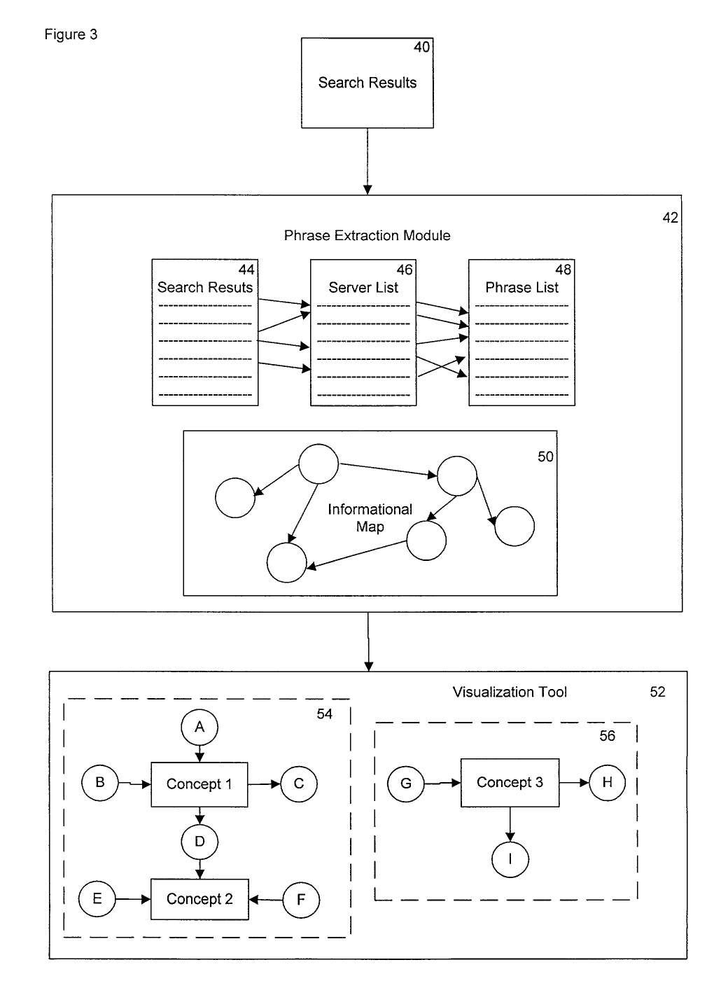

Referring to FIG. 3, there is shown a block diagram of the system implementing the preferred embodiment of the present invention. The input to the system comprises the search results 40 generated from a conventional search engine, such as a search engine available over the Internet and discussed above with regards to FIG. 1. Although this invention will be discussed with regard to Internet search engines and document located on the Internet, it should be appreciated by those of skill in the art that the present invention may be applied to any environment in which the user would like to search to wide variety of electronic documents and locate those which are conceptually related to each other.

The basic search results are provided as input to a phrase extraction module 42. This module analyzes the data for each of the hits in the search results and builds an information map linking the physical location of the documents (e.g., a server) with one or more phrases or concepts related to the identified documents. This process can be performed in several steps.

First, the search results 44 are analyzed to generate a list of each unique server 46 which contains one or more documents from the search results. For an Internet search, this list can comprise the set of unique Internet server addresses which contain all of the documents found by the search engine. The servers are preferably identified using their HTTP address. However, other identifiers, the server's IP address, may also be used. Other ways of identifying the location of the servers can also be used. It should be noted that the term “server” need not encompass an entire physical entity. Thus, a single computer system can host documents addressable through several different URL headers, and therefore a single physical computer may be represented in the list several times through each of its “names”. Once the set of servers has been identified, the documents in the search which reside on that server are identified and the data objects can be linked to each other.

Second, the text returned by the search engine and which is associated with each of the documents in the search results is analyzed to produce a table 48 of phrases or concepts contain within that text. Various techniques will be known those of skill in the art for generating such a concept list. Preferably, conventional frequency analysis of the text is used, during which frequently used an unimportant words are discarded, and key terms and/or phrases are identified and each concept in the list is also associated with a value or ranking indicating the frequency that the concept appears throughout the text “summaries” of each hit in the search results. Although conceptually, the concept list can be derived by accessing each document identified by the search directly, this can be very time consuming. Preferably, the indexing work already done by the search engine is exploited and only the descriptive text returned by the search engine for each hit is analyzed. Each concept phrase which is developed is linked (at least temporarily) to the various documents found in the search which contain that particular concept.

After the server and concept lists have been generated, the links between the server lists and the search results and the links between the concept list and the search results are analyzed to generate a direct set of links between each particular server in the server list and the one or more concepts in the concept list which are related to the documents located on that server. In other words, and as shown in FIG. 2, the server list and concept list are directly linked to each other without an intermediate linking to the search results. A separate set of links between the search results and one or both of the concept list and the server list may be separately maintained to permit easy access to the located documents on each server and the documents associated with each concept.

The resulting linked server and concept lists can be stored as files or data structures using conventional techniques, such as relational databases, and form an “informational map” 50 of the search results based on key phrases or concepts. This informational map permits a user to quickly identify those servers that contain documents related to particular concepts of interest and to eliminate those servers that contain documents that, while found in the search, address concepts which are not related to the overall object of the search.

A variety of techniques can be used to analyze and present the data in this informational map. Preferably, the information is presented to the user by means of a data visualization tool 52 which displays the map as a graphical image of concepts linked to servers. To further aid in the search, the informational map is preferably initially grouped into clusters 54, 56, each of which comprises a link groups of concepts and servers (e.g., a connected sub-graph). For example, servers A, B, C and D have all been linked to documents which contain concept 1. Servers D, E and F have been linked to documents which contain concept 2. Servers G, H and I are linked to documents which contain concept 3. Because server D is linked to both concept 1 and concept 2, the servers linked to both of these concepts are included within a single cluster. A second cluster comprises those servers connected to concept 3. By identifying clusters which contain those concepts that best describe the documents sought by the user, the identity of one or more servers in that cluster can then be used to filter the search results and thereby identify the specific documents identified in the search which are most relevant to the user.

Because a very large number of concepts may be generated during processing of a search, preferably the number of concepts initially analyzed and displayed by the visualization tool is restricted. For example, the visualization tool may be instructed to display only the 10% most frequently used concepts because the most frequently used concepts are less likely to result in links between clusters which are generally otherwise unrelated to each other. Although the search term itself will appear in every document, and therefore appear at the top of a frequency-of-use list, the search terms are generally not included in the concept list because their use would result in a cluster which contains every server and therefore would provide no aid to the user in focusing the search results.

As will be recognized by those of skill in the art, the number of concepts used to define the displayed clusters affects the accuracy of the result. In particular, false negative may be introduced wherein a set of servers are grouped in separate clusters even though the documents on those servers are generally related to each other. A cluster can also be to inclusive, particularly if too many concepts have been included in the set of concepts used during cluster analysis. Finally, some servers may be unattached to any particular concept, such as the case when that server is the only one which is linked to a particular concept and that concept has been excluded from the cluster analysis. (An unattached server may also be considered to be a cluster having a membership of one.) The balance between false positives, false negatives, and unattached servers can preferably be adjusted by user through an appropriate selection of, e.g., a cutoff frequency threshold used to select the particular concepts used during cluster analysis.

False positive can also be eliminated by manually removing a connection between regions of a cluster, to thereby creating two separate clusters. False negative can be resolved by selecting one or more servers in the wrongly separate clusters and identifying all concepts which are links to that server (e.g., those additional concepts not used during the initial cluster analysis). The user then selects one or more of these additional concepts to be added to the cluster analysis and thereby be available to link additional servers. By selecting these additional concepts carefully, closely related clusters will then be joined, either directly or through intermediate servers. This technique may also be used to explore concepts which are linked to unattached servers in order to identify concepts which will link them to existing larger clusters.

In the most preferred embodiment, the visualization is accomplished by means of the “Watson” Visualization Software Package which is available from Harlequin Software of Waltham, Mass. Additional information about the Watson tool is also contained in U.S. Pat. No. 6,052,693 issued Apr. 18, 2000 and entitled “System for Assembling Large Databases Through Information Extracted From Text Documents”, the entire contents of which is hereby expressly incorporated by reference. The visualization and analysis of the information map using a Watson-like visualization tool will now be discussed with reference to the remaining figures.

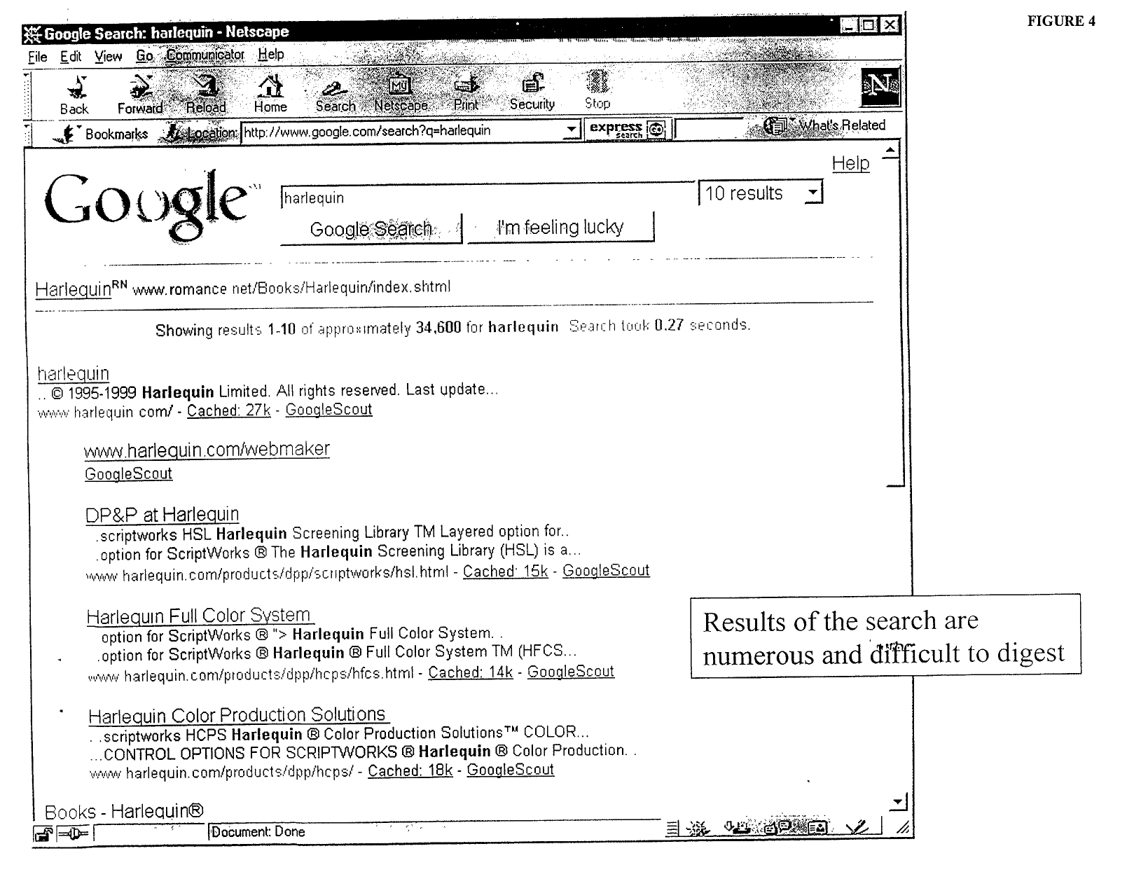

FIG. 4 is an illustration of a portion of the results returned from a conventional search. As shown, the search results comprises a generally unstructured list of “hits”, wherein each hit includes a document name, a hyper linked location indicating the server upon which the document resides, and a block of indexed text which includes keywords, concepts, or a portion of the text from the document which surrounds the indexed search terms. Preferably a search engine is used which includes text that is sufficient to place the search terms in context.

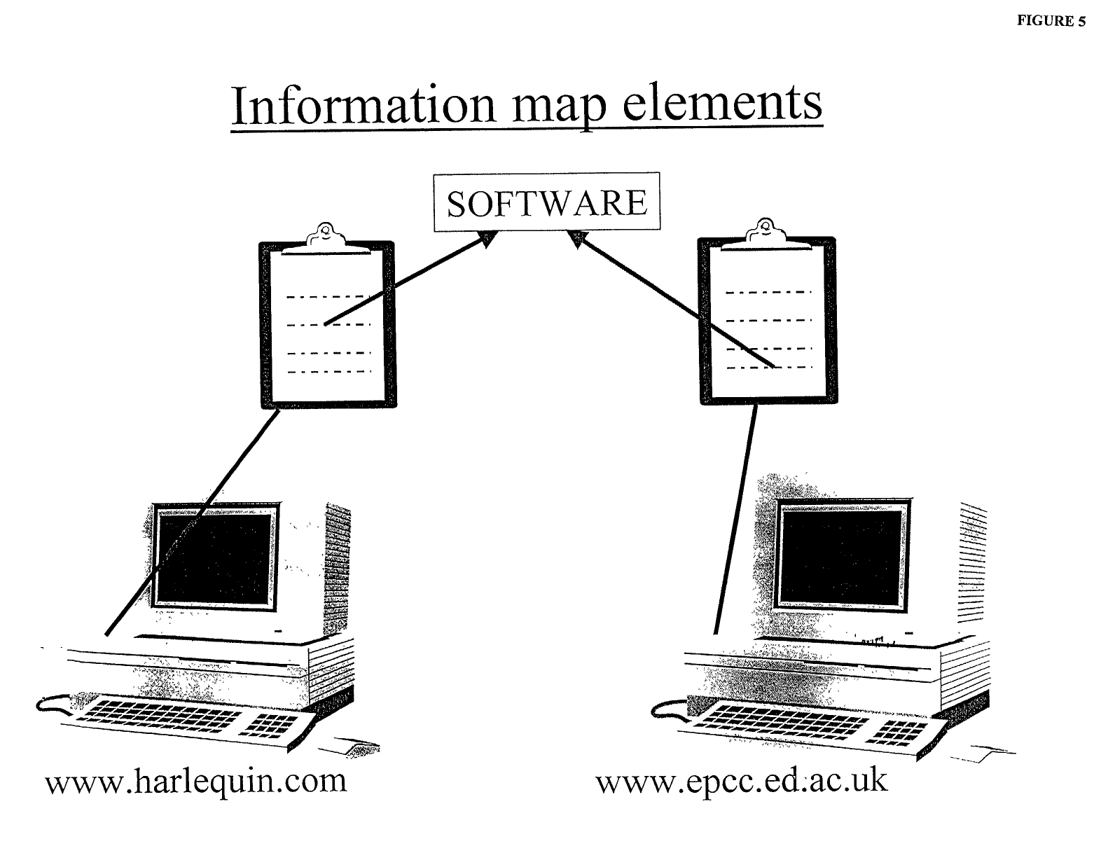

FIG. 5 is a graphical illustration showing how software implementing the preferred embodiment provides a conceptual link between two physically or logically remote servers, each of which contains a document identified in the search.

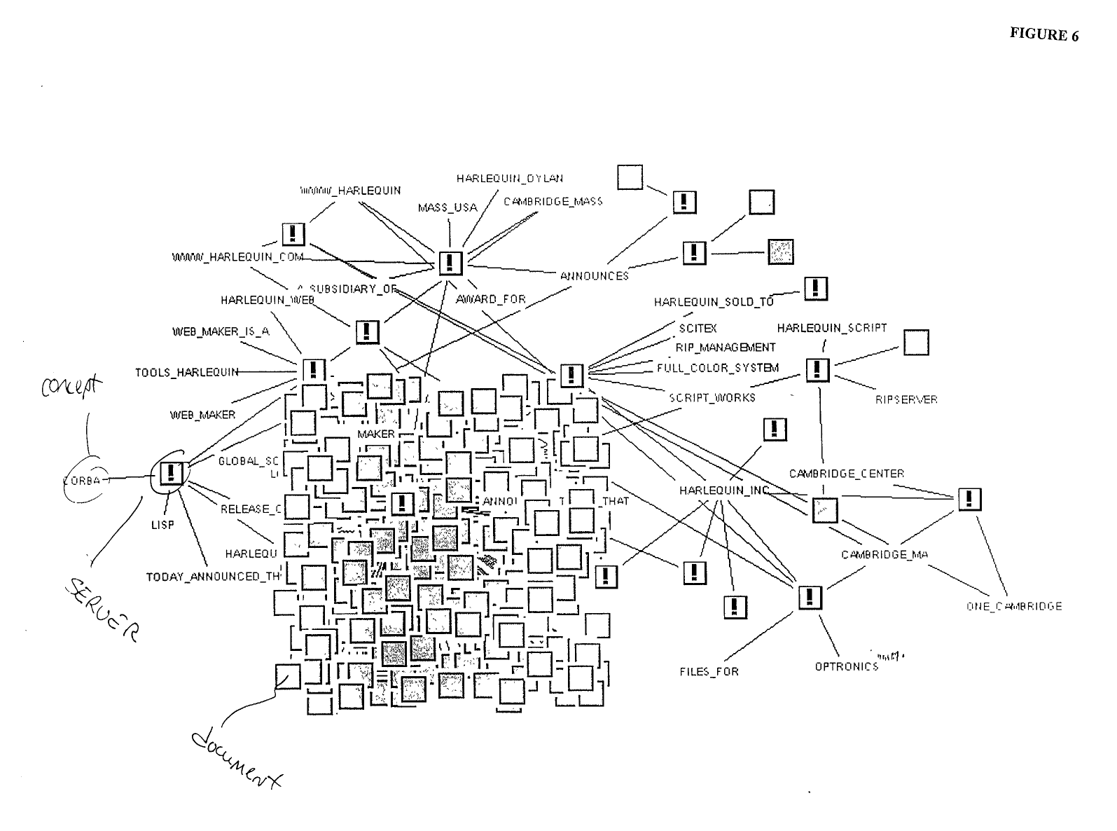

FIG. 6 is a graphical illustration of an informational map which shows a web of servers linked to concepts and also servers linked to documents. Because one server can contain a large number of documents, and as is apparent from view in the figure, displaying in a graphical format the documents linked to each server, such as shown in FIG. 6, generally results in a cluttered and impractical display.

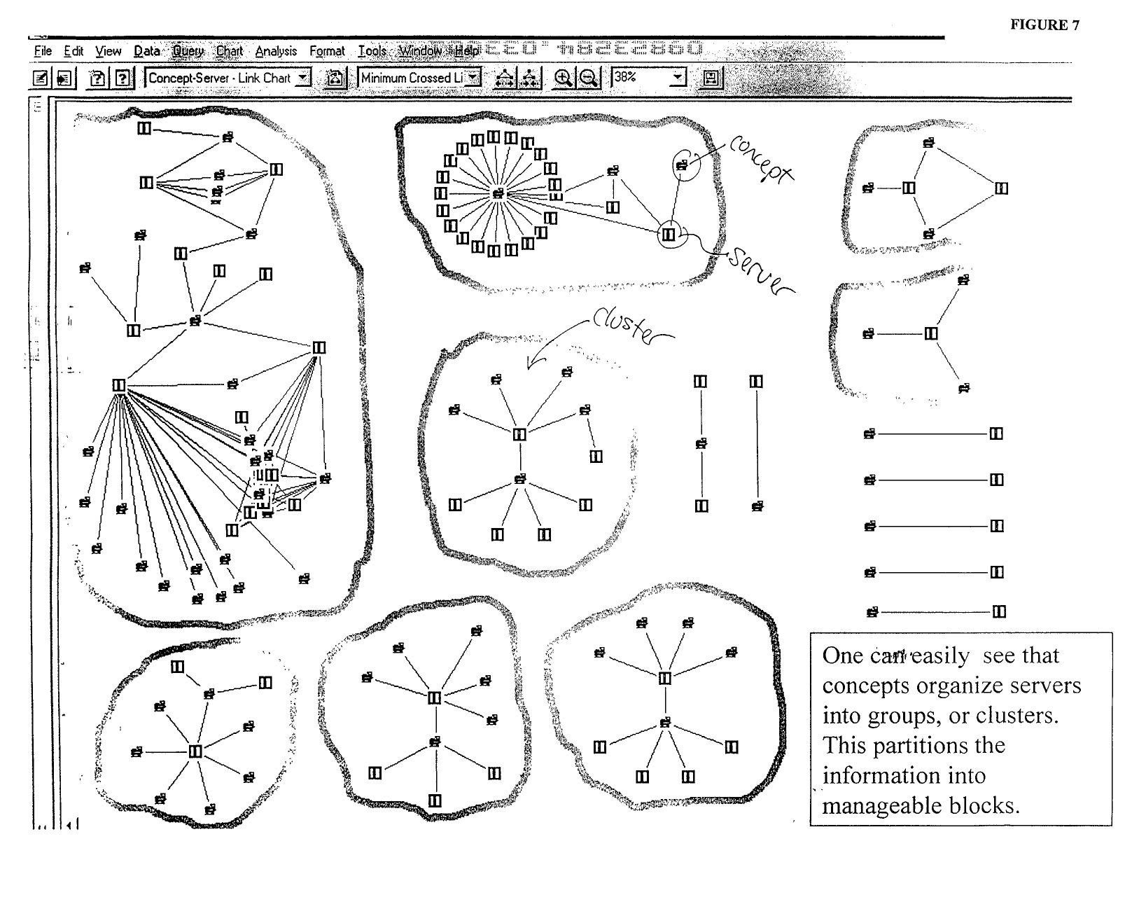

FIG. 7 is a graphical illustration of an initial clustering of search results according to a preferred embodiment of the invention and is a more complicated and complete version of the generic example illustrated previously in FIG. 3. As shown in FIG. 7, concepts and servers are shown as differently shaped icons and links between the concepts and servers are graphically displayed. In this diagram, the position of the links and icons has been selected to minimize the number of crossed lines. In addition, and as addressed more fully below, only a portion of the total set of concepts links are displayed.

In most circumstances, there will be several maximally connected sections of the overall informational map, which sections form discrete clusters of concepts and servers. Using conventional data analysis techniques, these clusters can be identified and the graphical display adjusted to show these clusters as discrete elements, optionally with a visual boundary to aid the user in identifying them.

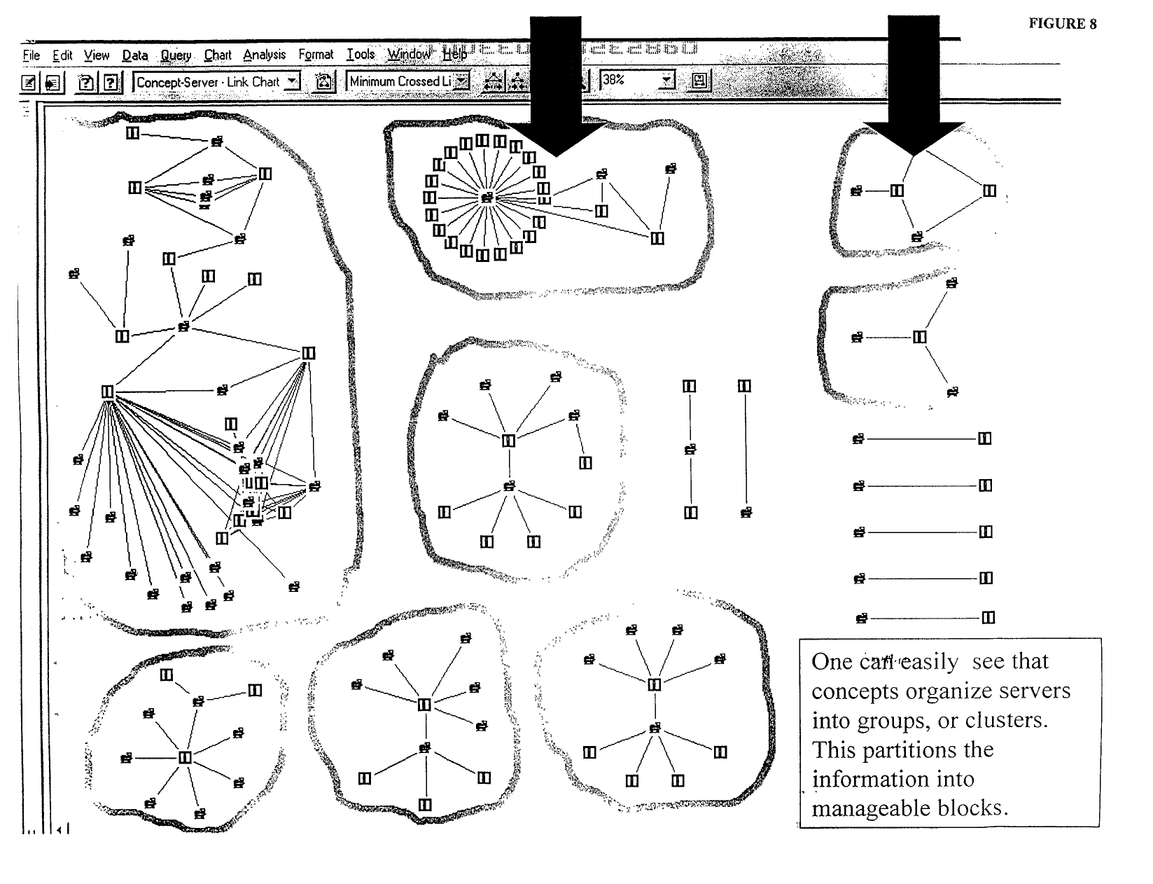

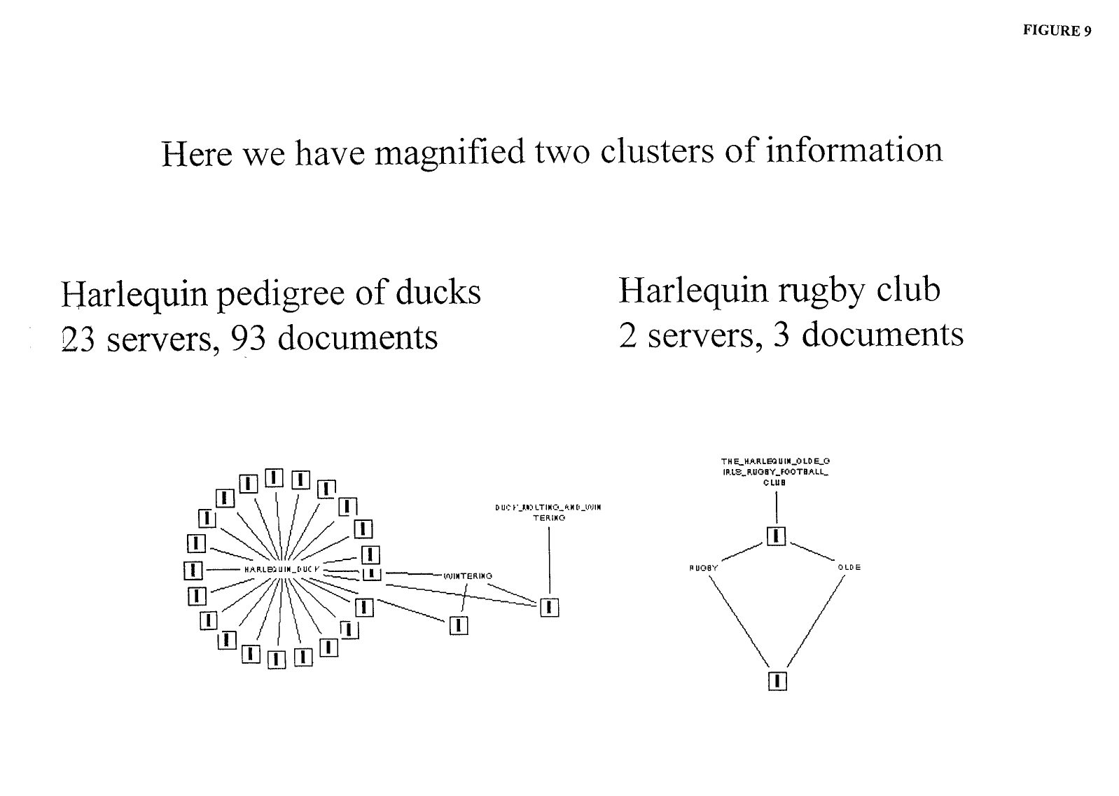

At this level of abstraction, and to reduce screen clutter, the actual concepts behind the icons in each cluster are not displayed. To obtain this information, the user selects one or more clusters. For example, in FIG. 8 two separate clusters have been selected for viewing. The clusters in expanded form are illustrated in FIG. 9. As shown, one cluster contains servers which address the concepts of harlequin ducks, wintering, and molting; whereas the second cluster address concepts related to the Harlequin Rugby Club. As will be readily appreciated, although a generic search for document containing Harlequin returned documents which address both of the these conceptual areas, it is unlikely that documents from both of these otherwise unrelated clusters will satisfy the user's needs.

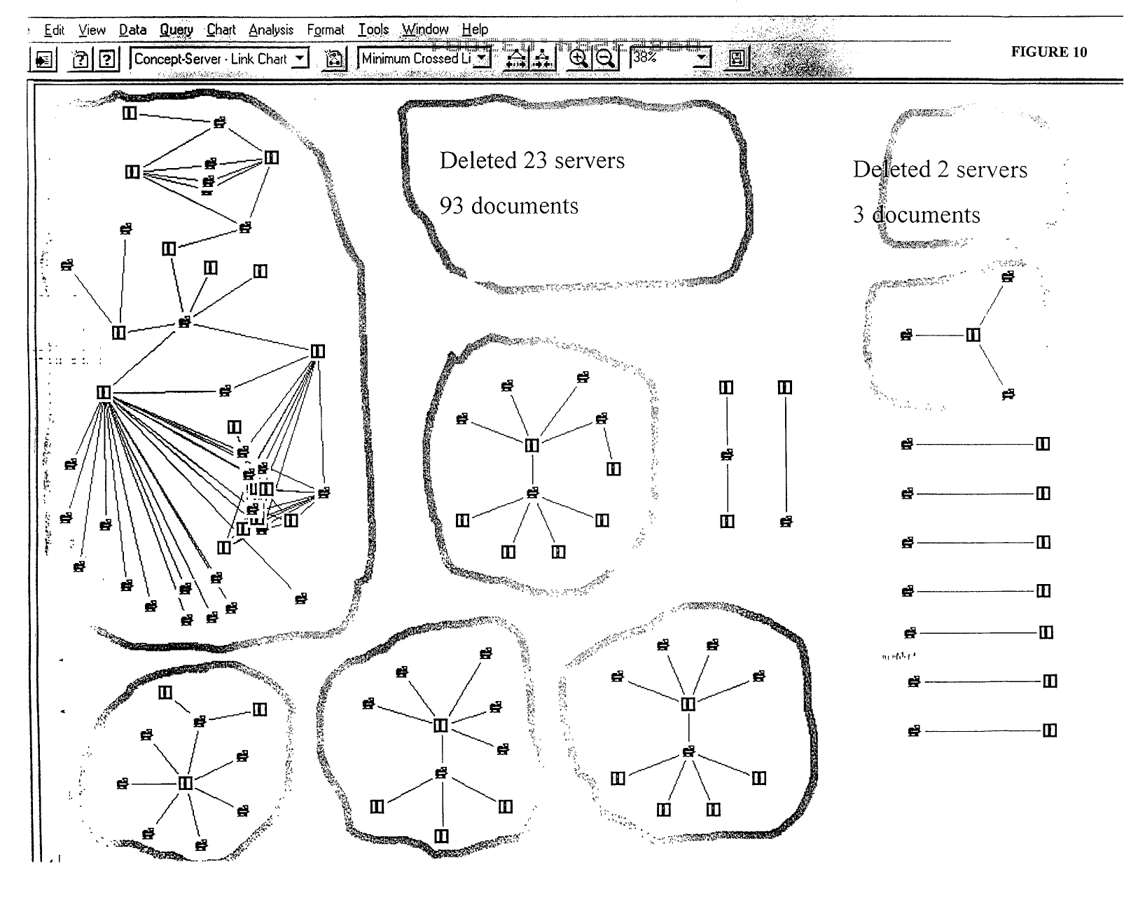

To refine the search, a user can delete from the information map the one or more clusters that contain concepts in which the user is not interested. For example, a user interested in documents that address Harlequin software is not interested in documents that address Harlequin ducks or rugby and therefore, and as shown in FIG. 10, the two clusters of the FIG. 9 can be deleted. As a result, 96 hits have been removed from the search results. Advantageously, this focusing of the search is performed without the user having to review of the any of the identified documents.

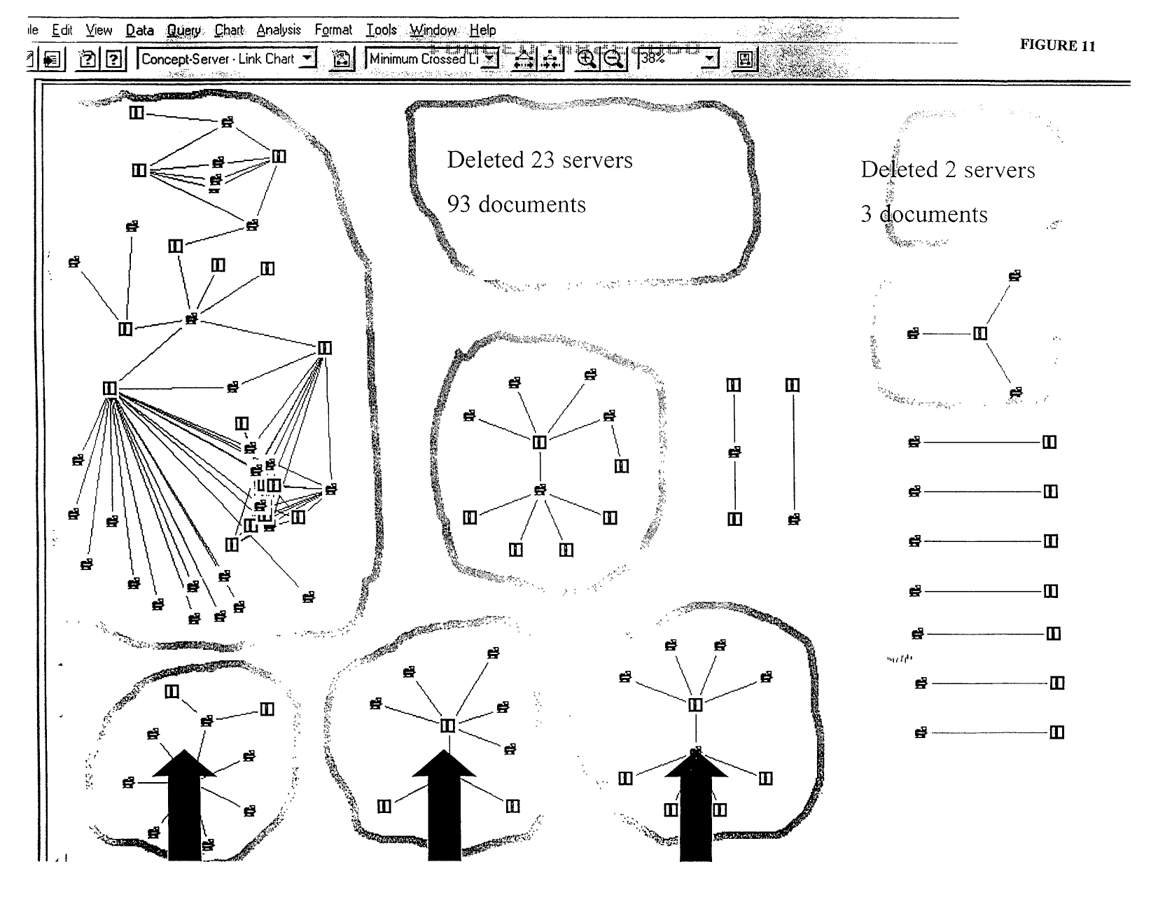

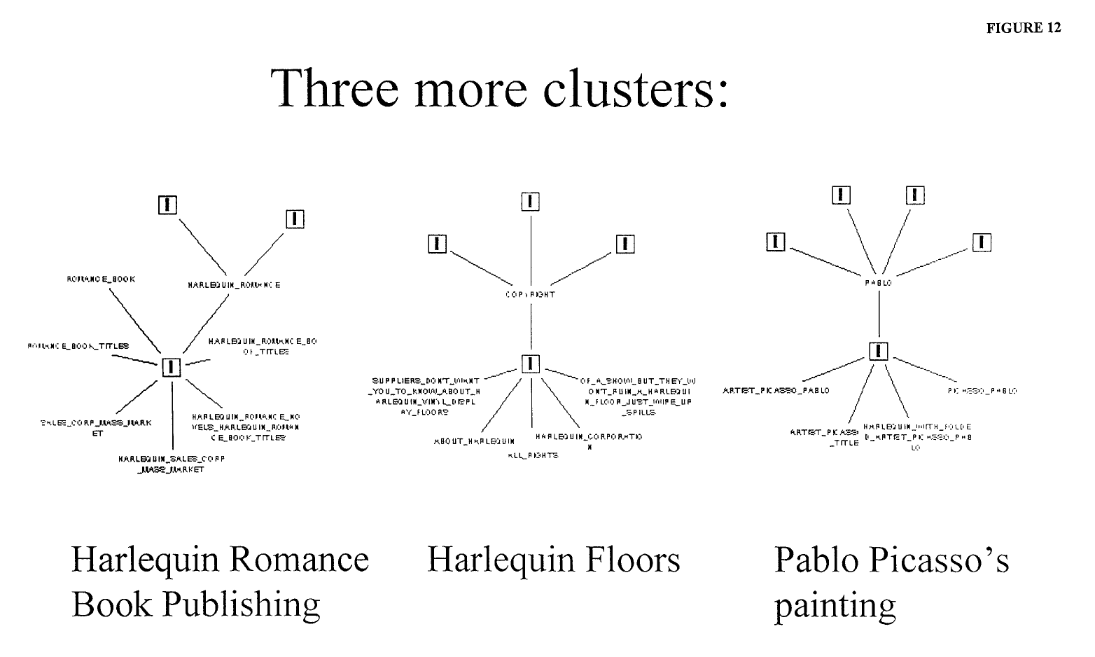

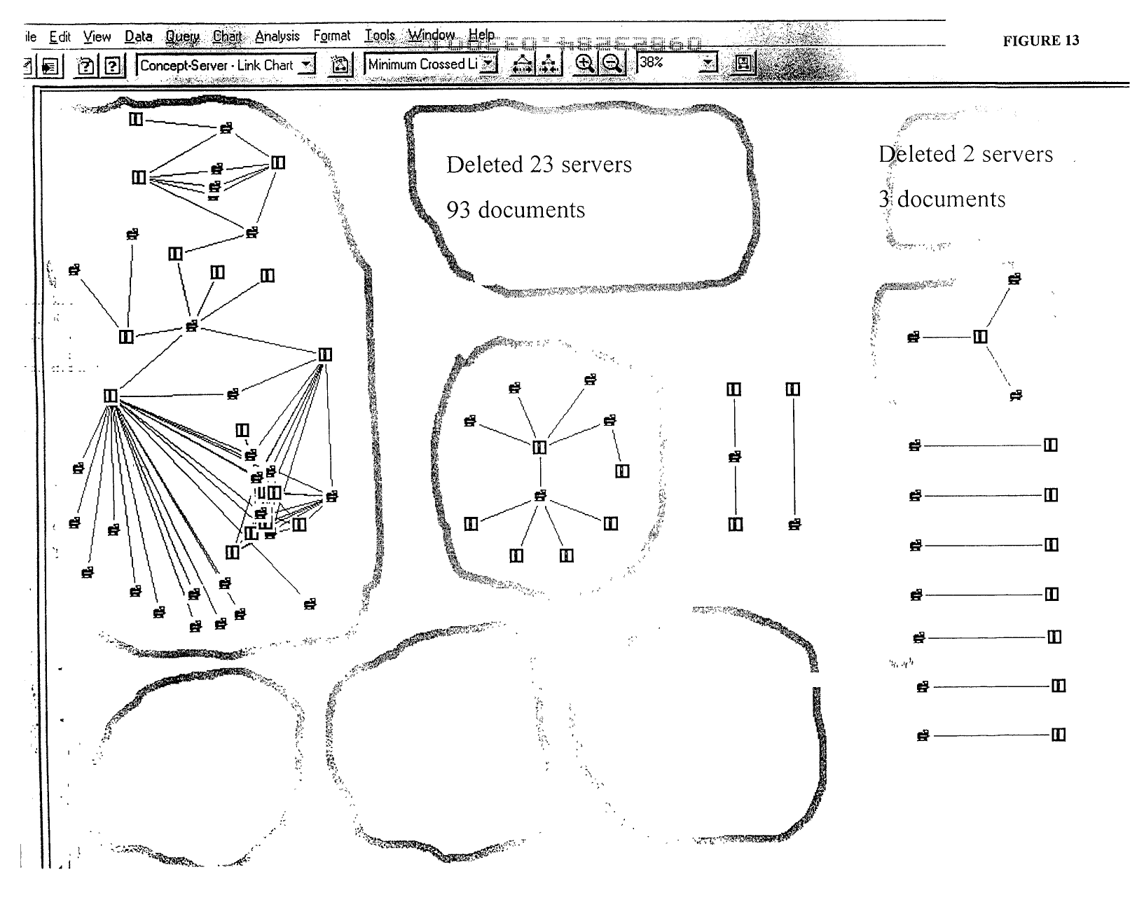

A second example of selection, expansion, and deletion of specific clusters are illustrated in FIGS. 11-13, respectively. As shown, these additional clusters are related to concepts which also do not encompass software. As will be appreciated by those skill in the art, various techniques can be used to select clusters. Preferably, the user is permitted to simply select one or more clusters by means of a mouse click and then select an appropriate function, such as “zoom” or “delete”.

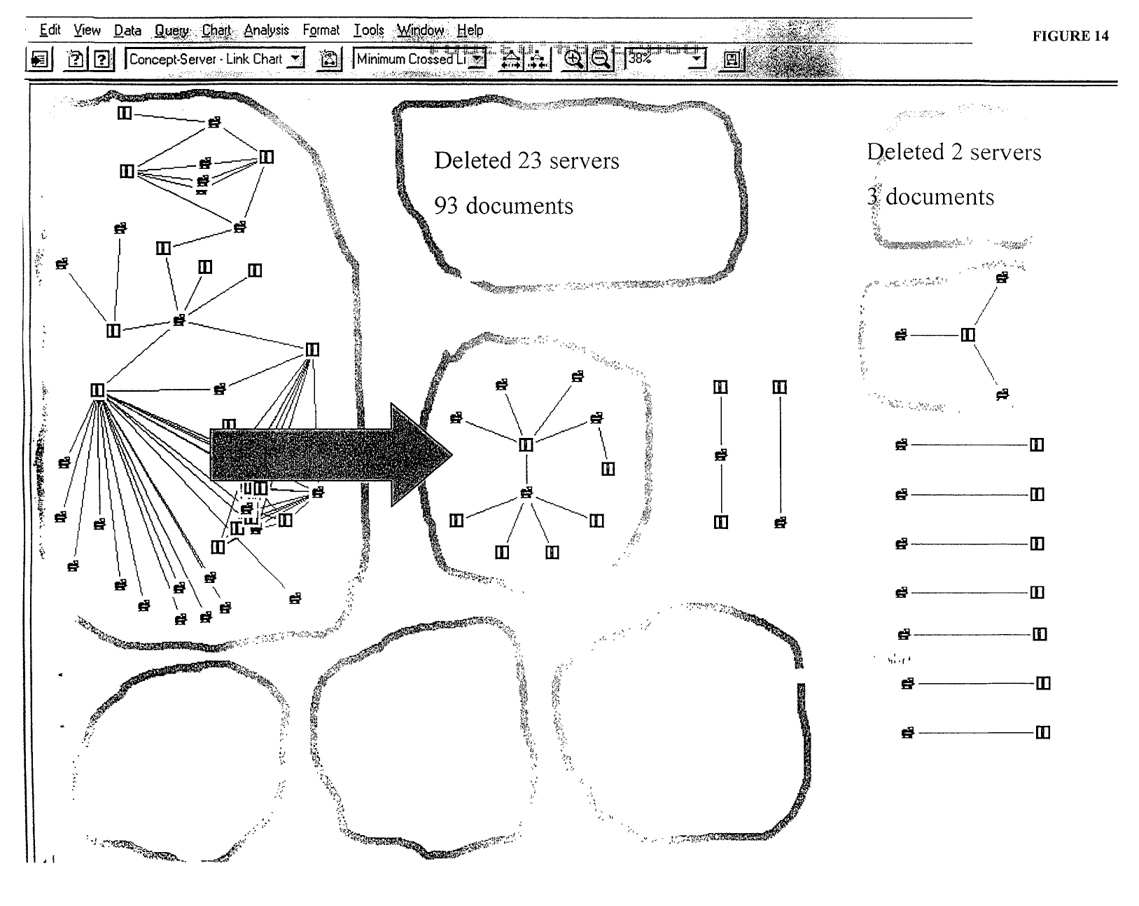

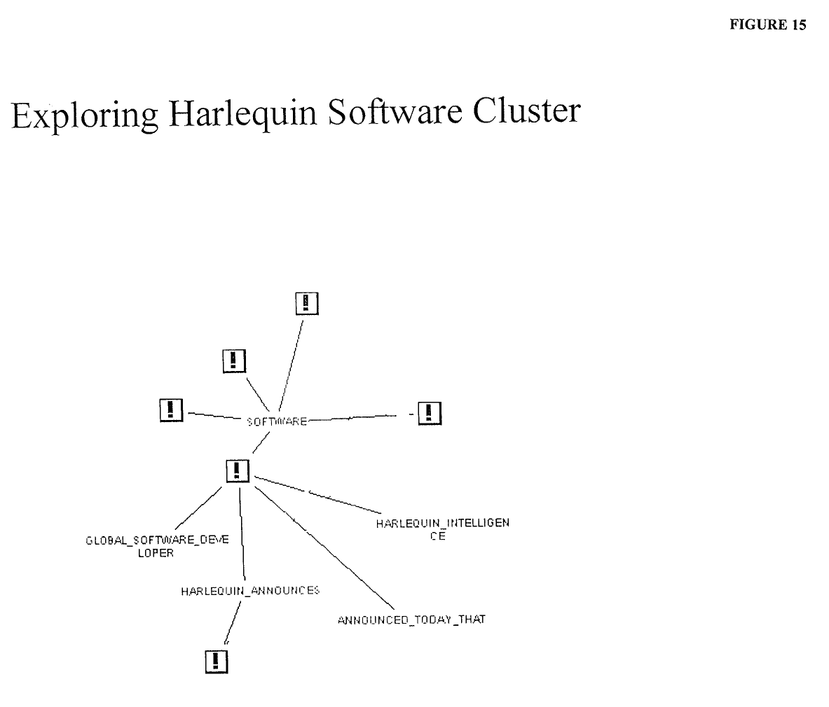

FIG. 14 illustrates the selection of yet another cluster for zooming. As shown in FIG. 15, which shows the zoomed cluster identified in FIG. 14, this cluster contains concepts related to software and therefore the documents on the servers in this cluster are very likely to be those in which the user is interested.

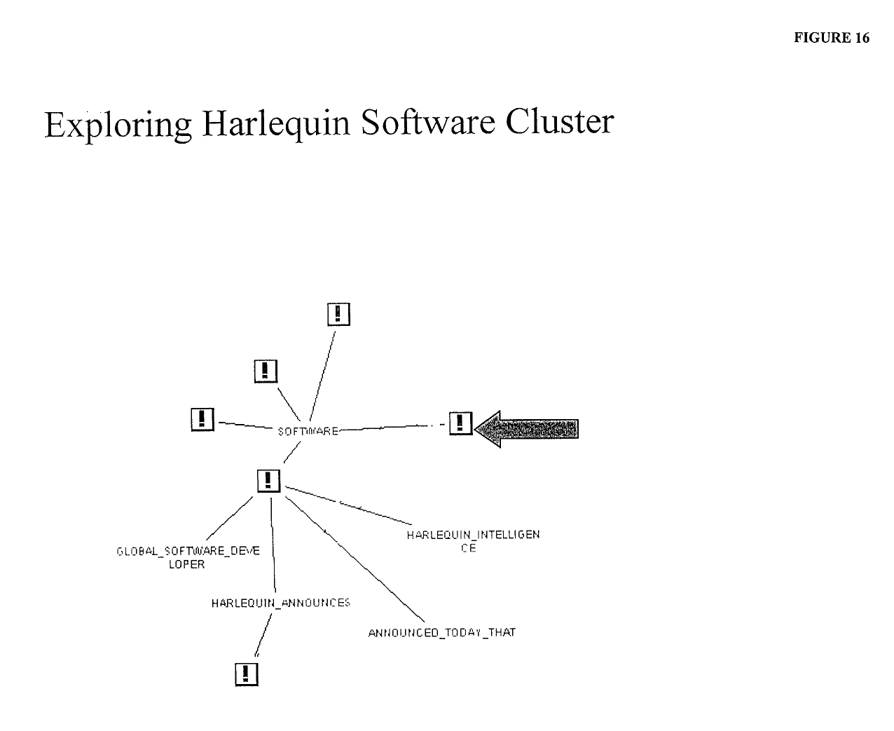

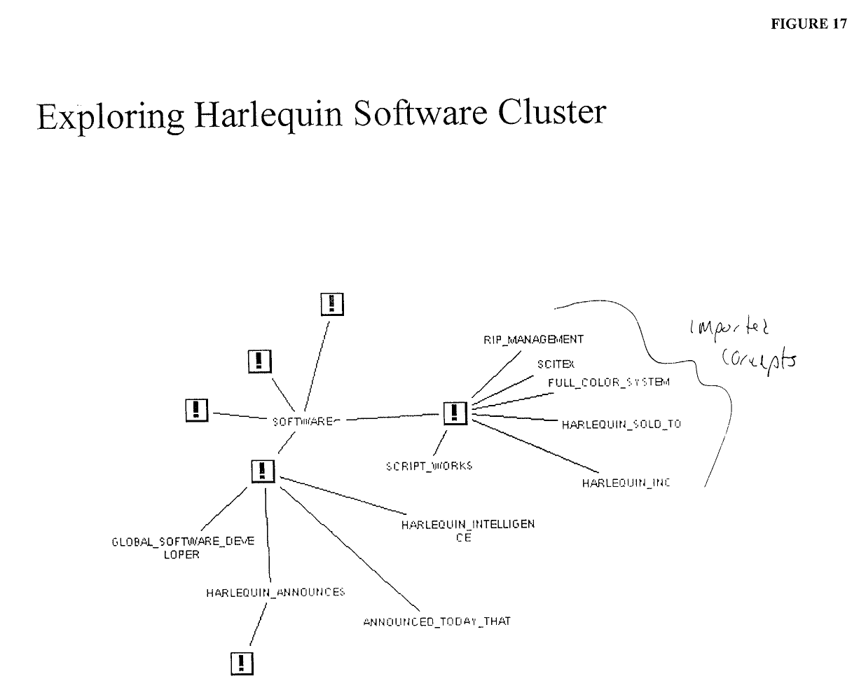

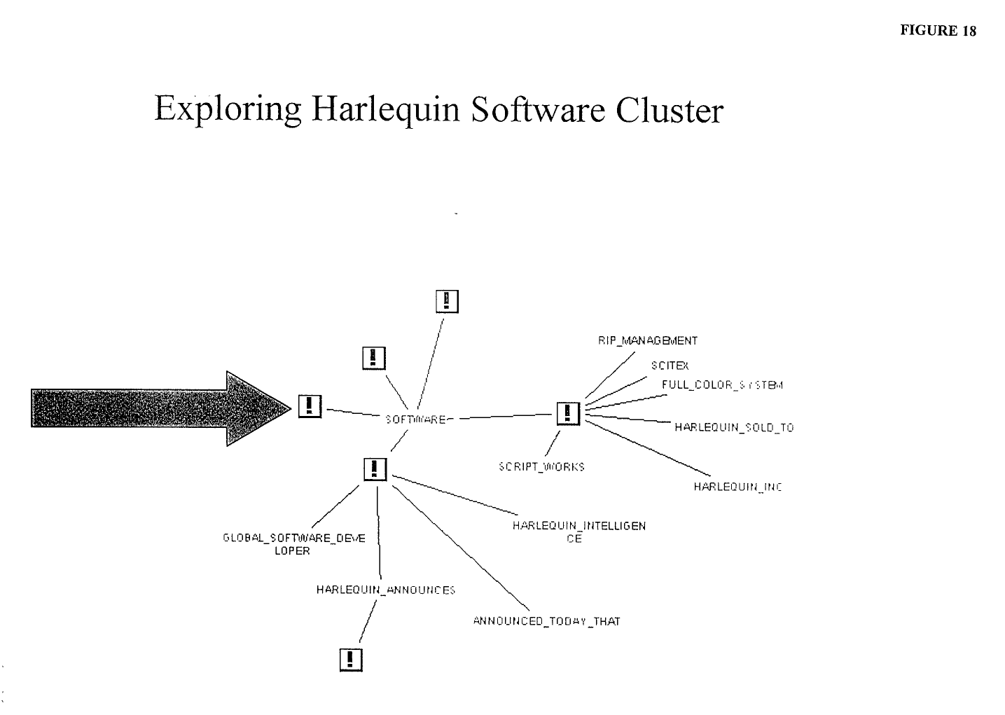

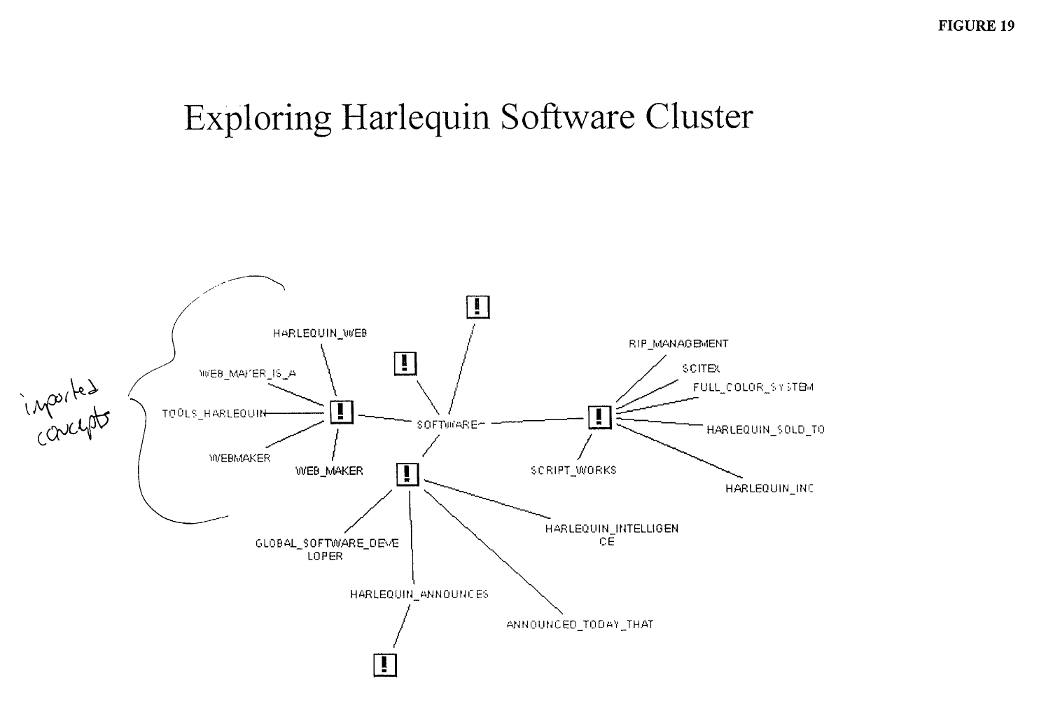

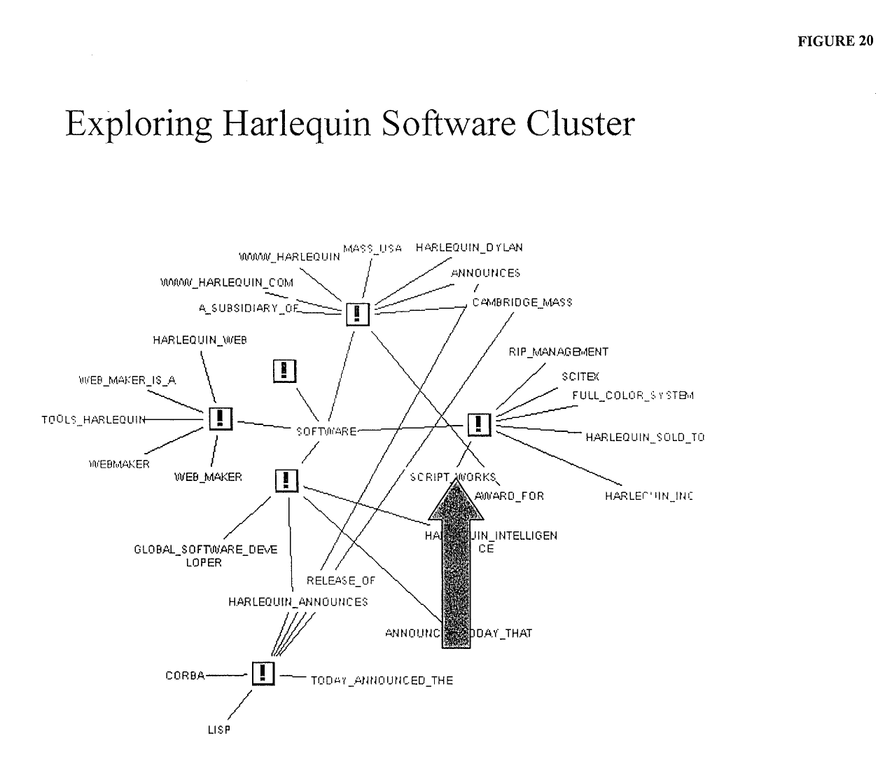

Because the initial cluster mapping can be generated using a subset of the total set of concepts, this cluster containing concepts related to the goal of the search may be too restrictive, omitting links to less frequently used concepts which are nevertheless relevant. Accordingly, a user can select a particular server and instruct the system to display all of the concepts linked to the selected server, such as shown in FIGS. 16 and 17. The imported concepts are those which were not considered during the initial cluster analysis. FIGS. 18 and 19 illustrate the selection of a second server and the importation of its concepts. For a complete linking, the user can select each server within a promising cluster and repeat this process. Alternatively, an automated mechanism can be provided when the user instructs the computer to add to the cluster all concepts linked to each server in the cluster. FIG. 20 is an illustration of the cluster of FIG. 15 after the concepts related to all of the servers in the cluster are imported.

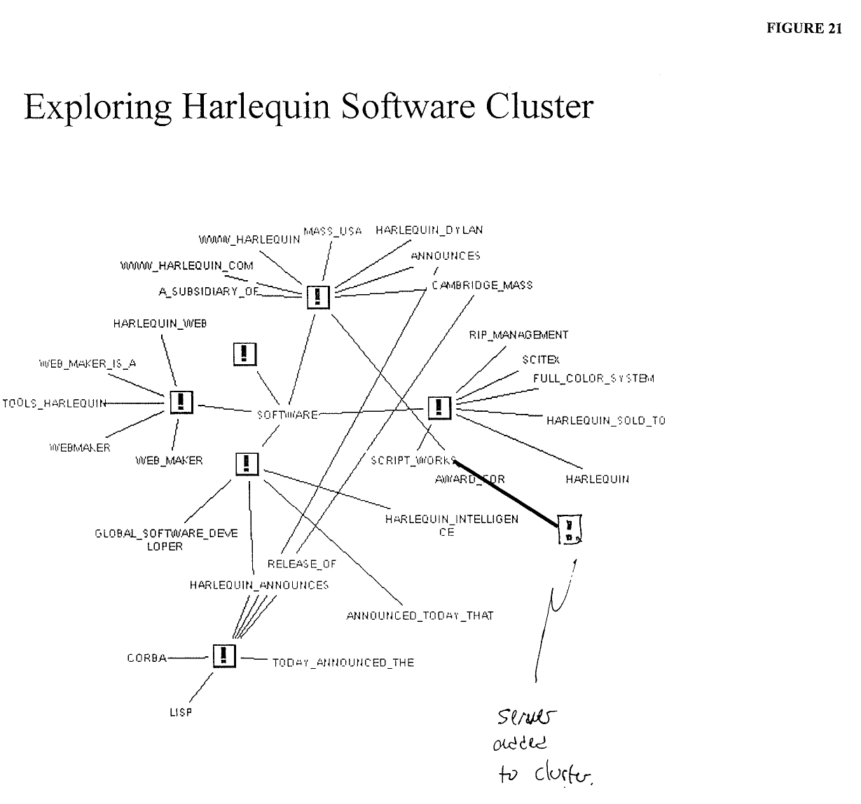

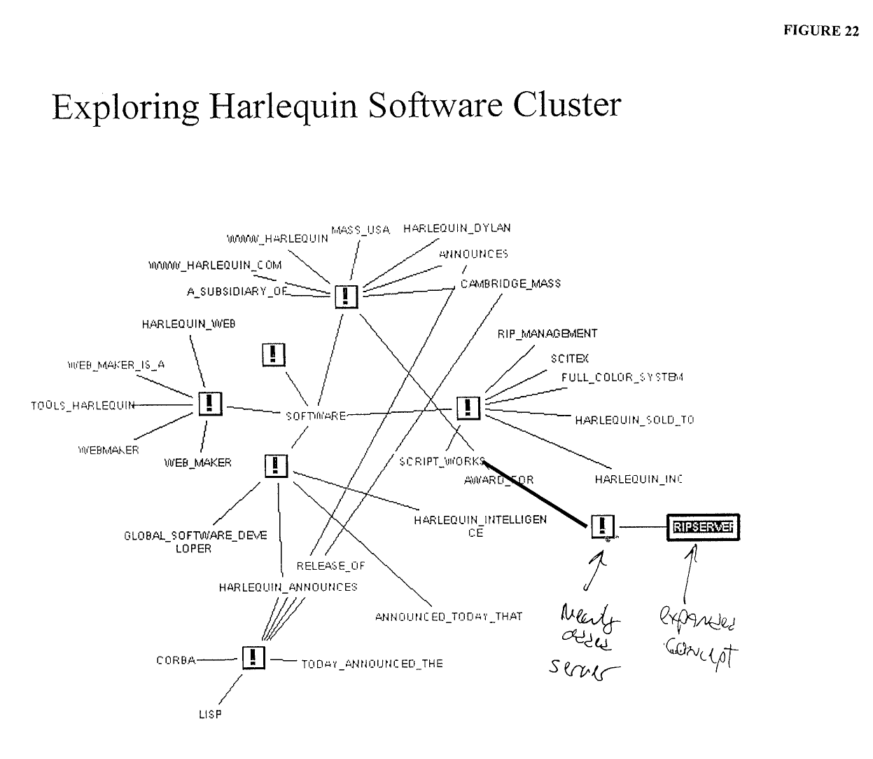

After additional concepts have been imported to a cluster, one or more of them can be selected and used to update the cluster mapping. In other words, the added concept will be used to link additional servers together. For example, in FIG. 20, the concept “script works” has been selected. This concept was not initially used in the cluster analysis and therefore, after being imported into the cluster of FIG. 20, is only linked to one of the servers in the cluster. Upon receiving the identity of the new of concepts, the system accesses the underlying information map linking the servers to the full set of concepts and identifies any additional servers which are linked to the selected concept. Any additional servers identified are then added to the cluster, such as graphically illustrated in FIG. 21. The overall process can be repeated. For example, the user can select the newly added server and import any additional concepts linked to that server, such as shown in FIG. 22, and then optionally link additional servers to the imported concepts, etc.

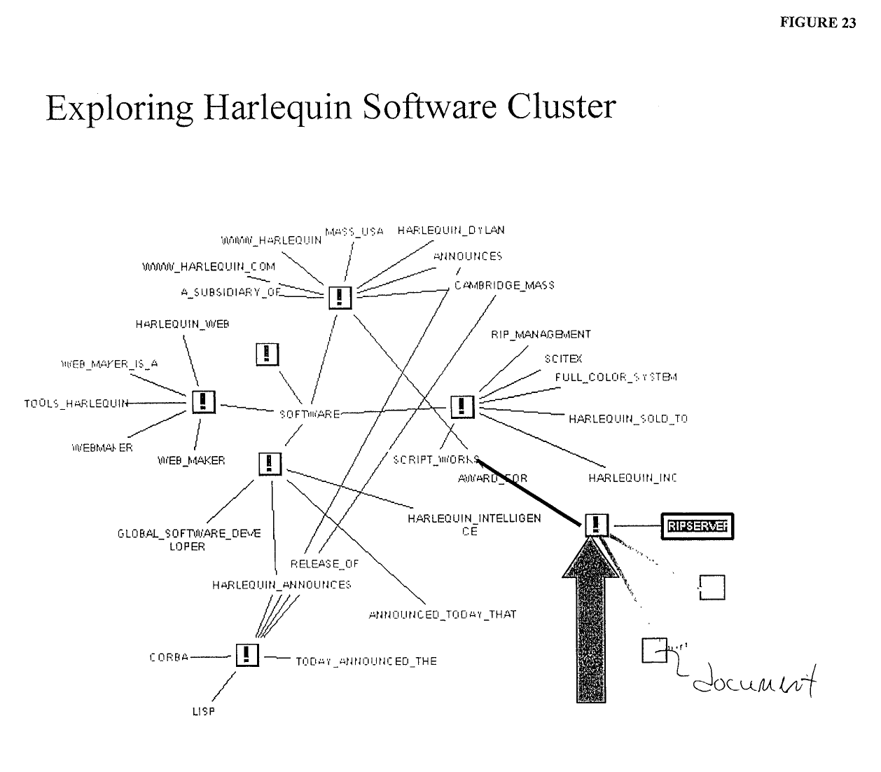

In addition to displaying servers and concepts, a user can select a particular server and request that documents linked to that server be displayed in the map. For example, in FIG. 23, a selected server contains two of the documents located during the initial search. The identified documents can then easily be retrieved from the appropriate server using conventional Internet technology and stored or otherwise presented to the user for viewing. In one embodiment, a selected document is retrieved using an Internet browser and the document is displayed in a framed window, with the data map displayed as a separate data object. Various other techniques for accessing the documents are known to those skilled in the art and depend on the type of computer system on which the invention is implemented and the manner in which the documents of interest are stored.

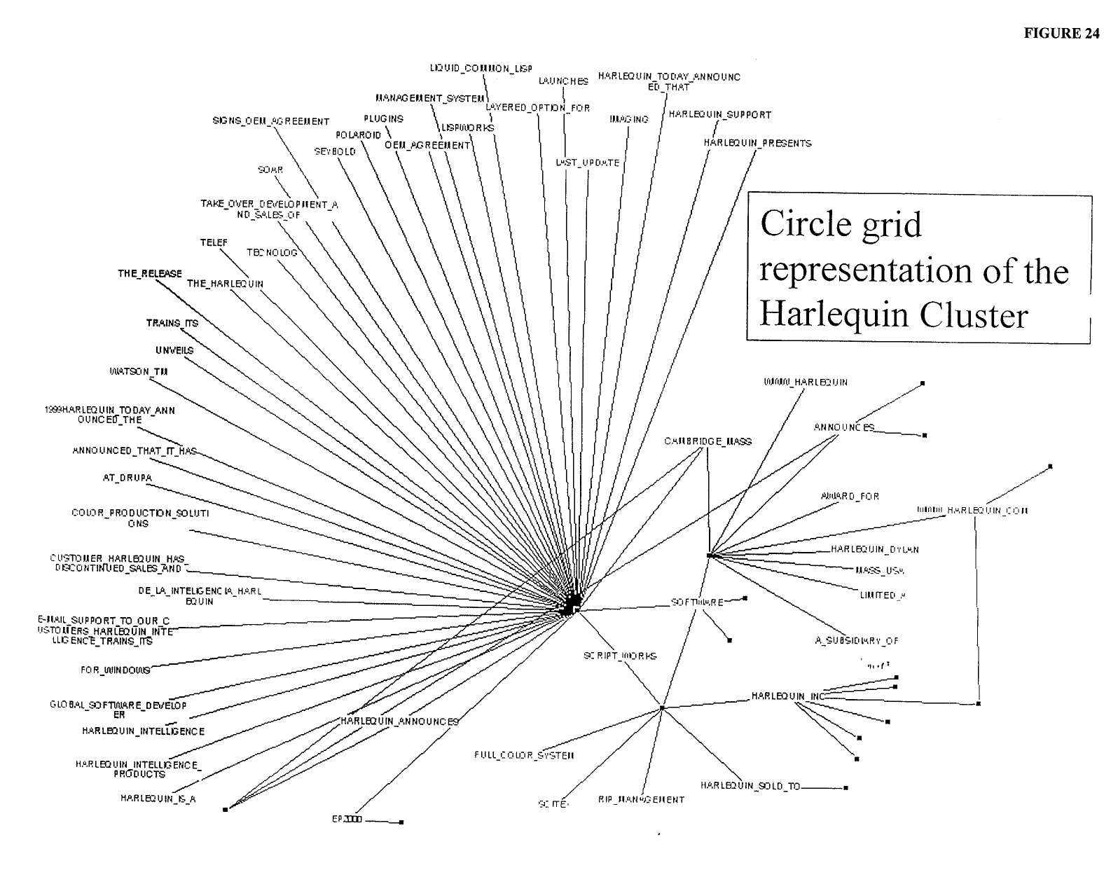

It can be appreciated that various different visualization techniques can be used to present the data map to the user. A variation of the map of FIG. 23 is shown in FIG. 24. Whereas the graph in FIG. 23 shows a graph which is displayed so as to minimize the number of cross links between elements, the graph in FIG. 24 is arranged according to a circle grid algorithm. Various techniques for positioning graphical elements in this and other manners will be known to those of skill in the art. Particular algorithm are implemented in the Watson software discussed above.

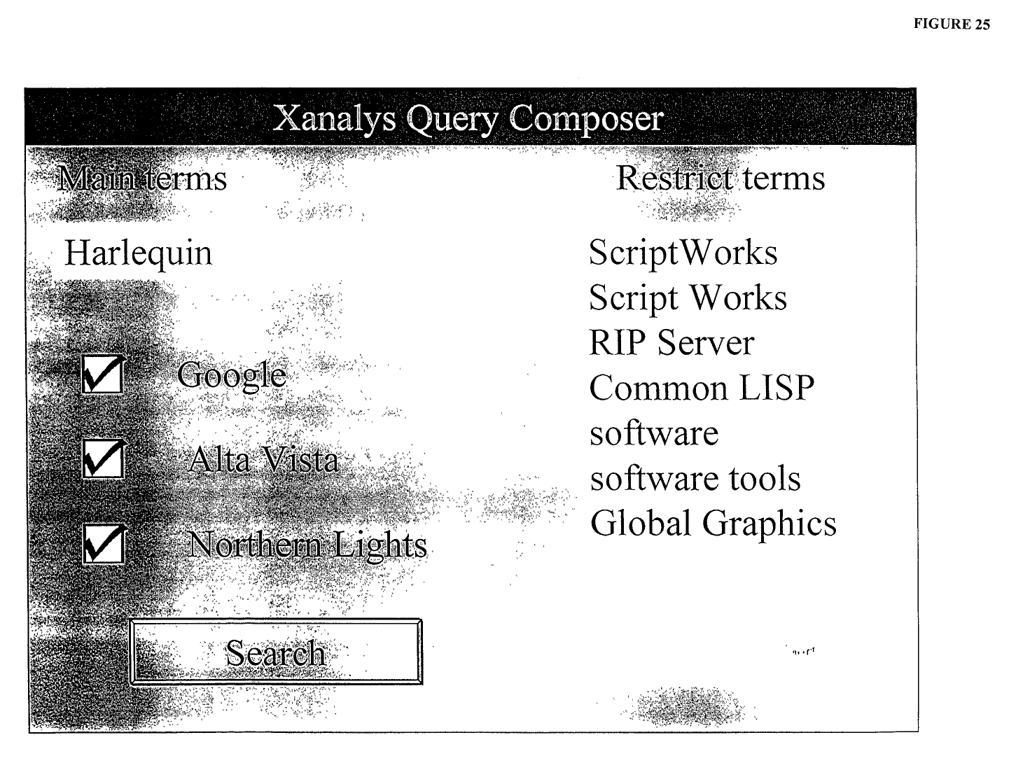

According to a further aspect of the invention, the mapped search results can be processed and used to develop a more focused search. With reference to FIG. 25, the user can be presented their initial query, as well as a menu or table of additional terms which are taken from one or more identified relevant clusters. The user can then select one or more of these additional concepts and use them to restrict the scope of the search. The user may also be permitted to select between one or more of several search engines. Upon selecting the additional restrictive terms, an appropriate search query is automatically generated and passed to the search engines. The results of the search can then be presented directly to the user or processed according to the phrase extraction and graphical display methods discussed above.

As will be appreciated, many searches are conducted without knowledge of the appropriate concepts most suited to narrow the search, particularly where the same concept may be addressed using a various terminology, or vice versa. Thus, it is common for initial searches to be extremely broad and the results to contain a large percentage of irrelevant hits. Further, because many tens of thousands of hits can be generated, search engines typically restrict the maximum number of hits returned, e.g., to 500 or 1000. Thus, many relevant documents may never be presented to the user. By permitting the user to utilize a query expansion tool to focus their search using conceptual terms identified as being generally on point, a more focused search can be performed, the results of which are likely to contain a higher percentage of relevant documents because the search terms will ensure that more irrelevant documents are screened out.

In addition to permitting the user to perform advanced query formations, the graphical and information relationship derived using the above described techniques are also useful in researching appropriate terminology to describe a particular concept in which the user is interested. Further, the system can be used for organizational research by identifying which companies or organizations support the servers identified in a particular cluster. This information can then be used to identify which companies are active in the subject area being searched by the user.

Because the visualization technique of the invention does not require that the underlying documents be directly accessed, but instead relies upon abstracts or text segments contained in search engine and indexes, automatic and interactive hit analysis and document clustering according to the invention can easily be implemented in real-time. Thus, while in one embodiment, the system and method of the invention operates on a search list returned to a user, the system can also easily be integrated into a conventional search engine, wherein the initial unstructured search results generated by the search engine are not transmitted directly to the user, but instead are used to generate informational maps, which are then used to generated graphical web pages that are served to the user and from which the user can perform the above discussed selection, expansion, etc. functions. The functionality can be implemented entirely on the server. Alternatively, some or all of the functionality can be implemented on the client side, e.g., by means of an appropriate Java or ActiveX program.

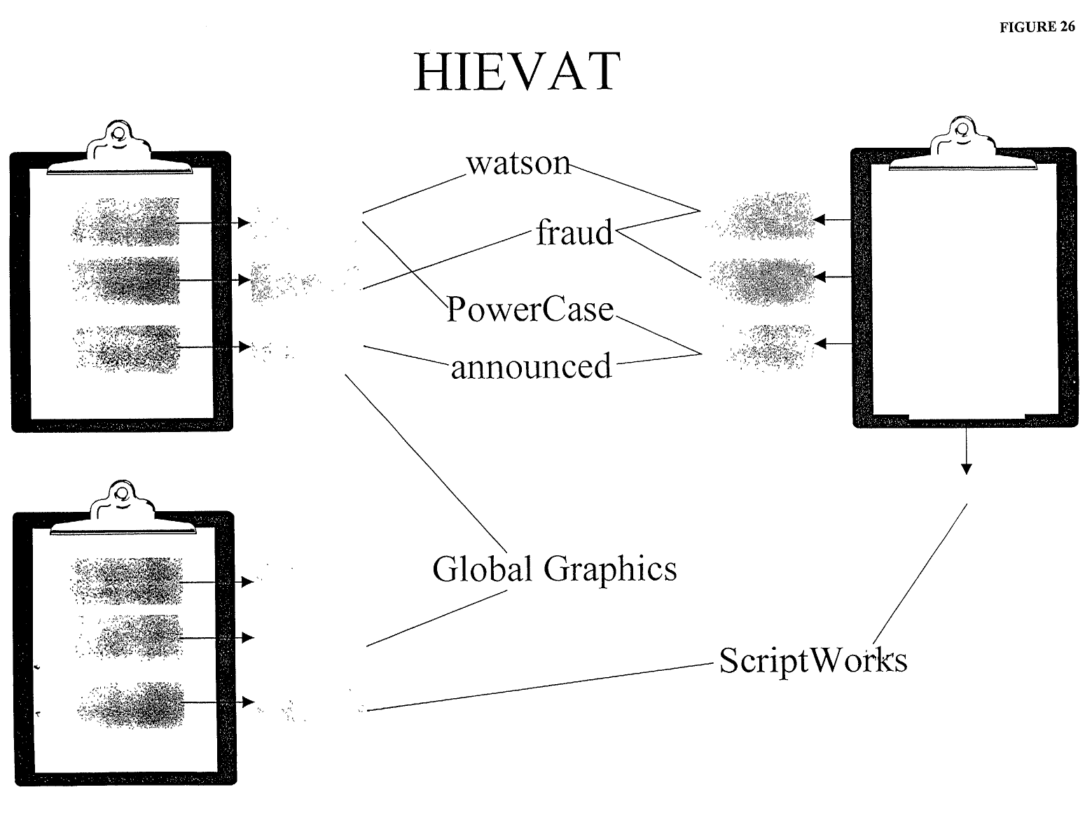

According to a preferred implementation of the invention, once one or more relevant clusters have been identified by the user, the documents contained on the servers in the selected clusters are downloaded and analyzed to identify the specific concepts addressed by the entire document, which concepts may not have been fully captured by the brief text segments provided by the search engine. The downloaded documents are then linked to each other according to their identified concepts, and a threaded index of topics which can be navigated by the user is generated. By using such an index, the user can quickly access portions of various documents in the cluster which address similar concepts. The index can be displayed texturally, or can be displayed using graphical techniques. A graphical illustration of such document linking is illustrated in FIG. 26. In the more preferred embodiments, such document indexing is performed using a HIEVAT™ software package available from Harlequin software of Waltham, Mass.

While the invention has been particularly shown and described with reference to preferred embodiments thereof, it will be understood by those skilled in the art that various changes in form and details may be made therein without departing from the spirit and scope of the invention.

I claim:

1. A search engine for searching files on a network of servers, comprising:
a. a phrase extraction module for determining select phrases that are contained in a selection of files and mapping phrases with the files and the servers hosting the files; and
b. a visualization tool for presenting a graphical representation of the mapping of said phrases, files, and servers.

2. A search engine for searching files on a network of servers according to a query from a user, comprising:
a. a phrase extraction module for determining select phrases that are contained in a plurality of files satisfying the query, and grouping the servers that host the plurality of files in accordance with the selected phrases; and
b. a visualization tool for displaying to the user, a graphical representation of the grouping of said phrases and servers.

3. A method for searching for files on a network according to a query from a user, comprising the steps of:
a. selecting files in accordance with the query;
b. determining one or more phrases contained in the selected files;
c. grouping the selected files in accordance with the determined phrases; and
d. displaying a graphical representation of the grouping to the user.

4. A method for searching for files on a network of servers according to a query from a user, comprising the steps of:
a. selecting files in accordance with the query;
b. determining one or more phrases contained in the selected files;
c. grouping the selected files in accordance with the determined phrases and in accordance with the servers hosting the selected files; and
d. displaying a graphical representation of the grouping to the user.

5. A method for analyzing search results for a user comprising the steps of:
a. receiving search results from a search engine;
b. determining phrases based on files referenced by the search results;
c. determining servers hosting the files referenced by the search results;
d. generating a map associating said phrases with said servers wherein a phrase is associated with a server if the phrase occurs in a file referenced by the search results located on the server;
e. identifying one or more server clusters in accordance with the map; and
f. displaying the server clusters to the user.

6. The method of claim 5, further comprising the steps of:
a. receiving from the user a selection of one or more clusters;
b. removing said selected clusters from the display; and
c. adjusting the display of the unselected clusters.

7. The method of claim 5, further comprising the steps of:
a. receiving from the user a selection of clusters;
b. revising the map associating additional phrases with the servers in the selected clusters; and
c. displaying the selected clusters to the use in accordance with the revised map.

8. The method of claim 5, further comprising the steps of:
a. receiving from the user a selection of clusters;
b. revising the search results in accordance with the selected clusters;
c. adjusting the map in accordance with the revised search results; and
d. displaying the server clusters to the user in accordance with the adjusted map.

9. The method of claim 5, further comprising the steps of:
a. receiving from the user a selection of clusters;
b. receiving from the user a search query;
c. refining the search results according to the search query and the selection of clusters;
d. updating the map in accordance with the refined search results; and
e. adjusting the display of the clusters in accordance with the updated map.

10. The method of claim 5, further comprising the steps of:
a. receiving from the user revised phrases;
b. revising the map associating the revised phrases with the servers associated with files referenced in the search results; and
c. displaying the server clusters to the user in accordance with the revised map.

11. A method for revising search results generated by a search engine, comprising the steps of:
a. analyzing data associated with the search results;
b. generating a list of phrases based on the analyzed data;
c. identifying files referenced by the search results containing a phrase from the list of phrases; and
d. associating the files with phrases.

12. The method of claim 11, further comprising the steps of:
a. determining the frequency of use of each phrase in each file; and
b. including the phrase in the list of phrases if the frequency for the phrase exceeds a threshold value.

13. A method for refining search results in the form of a mapping between files, phrases and servers, for a user comprising the steps of:
a. receiving from the user a selection of a server;
b. importing one or more phrases contained in the files hosted on the selected server; and
c. displaying the imported phrases in a graphical representation of the mapping between files, phrase, and servers.

14. A method for analyzing search results for locating files on a network, the method comprising the steps of:
a. extracting phrases from the search results, wherein the phrases represent the subject matter contained in the files associated with the search results;
b. grouping the files into one or more clusters wherein each cluster contains two or more files such that each pair of files are associated with at least one phrase in common; and
c. generating a map of the grouping of files and phrases.

15. A method for searching files on a network of servers according to a query from a user, comprising the steps of:
a. determining select phrases that are contained in the one or more files satisfying the query from the user;
b. grouping the servers that host the one or more files in accordance with the selected phrases;
c. displaying to the user, a graphical representation of the grouping of said phrases and said servers;
d. receiving from the user, a selection of one or more groups;
e. generating a revised query according to the selection of one or more groups;
f. determining one or more files that satisfy the revised query; and
g. displaying to the user, a graphical representation of the one or more determined files.

16. A method for searching files on a network of servers according to a query from a user, comprising the steps of:
a. determining select phrases that are contained in the one or more files satisfying the query from the user;
b. grouping the one or more servers that host the one or more files in accordance with the select phrases;
c. displaying to the user, a graphical representation of the grouping of said phrases, said servers, and said files;
d. receiving from the user, a selection of one or more files displayed in the graphical representation;
e. downloading the selected files; and
f. generating links between the downloaded files according to the select phrases.
